(19) United States
(12) Patent Application Publication
(10) Pub. No.: US 2025/0046051 A1
(43) Pub. Date: Feb. 6, 2025

(54) PROCESSING CONTROL METHOD AND APPARATUS, AND DEVICE

(71) Applicant: MAKEBLOCK CO., LTD., Shenzhen, Guangdong (CN)

(72) Inventor: Yuanxiu ZHANG, Shenzhen, Guangdong (CN)

(73) Assignee: MAKEBLOCK CO., LTD., Shenzhen, Guangdong (CN)

(21) Appl. No.: 18/705,198

(22) PCT Filed: Aug. 31, 2022
(86) PCT No.: PCT/CN2022/116325

§ 371 Date: Apr. 26, 2024

(30) Foreign Application Priority Data
Oct. 26, 2021 (CN) 202111249139.6

(51) Int. Cl. G06V 10/20; G06T 7/13; G06T 7/73; G06T 11/40; G06T 11/60; G06V 10/75

(52) U.S. Cl. CPC G06V 10/255; G06T 7/13; G06T 7/73; G06T 11/40; G06T 11/60; G06V 10/751

(57) ABSTRACT

A processing control method and device and a medium are provided. The method comprises: obtaining a captured image of a processing platform, wherein at least one carrier is placed on the processing platform; determining a carrier among the at least one carrier in the captured image as a seed carrier, wherein the seed carrier is superimposed with a target processing pattern; determining a target carrier in the captured image, wherein the target carrier is a carrier that matches a shape of the seed carrier, among the at least one carrier; and superimposing the target processing pattern on the target carrier in the captured image.

This application is the national phase of International Application No. PCT/CN2022/116325, titled “PROCESSING CONTROL METHOD AND APPARATUS, AND DEVICE”, filed on Aug. 31, 2022, which claims priority to Chinese Patent Application No. 2021112491396, titled “PROCESSING CONTROL METHOD AND APPARATUS, AND DEVICE”, filed on Oct. 26, 2021 with the China National Intellectual Property Administration, both of which are incorporated herein by reference in their entireties.

### FIELD

The present disclosure relates to the technical filed of material processing, and in particular to a processing control method and apparatus, and a device.

### BACKGROUND

Processing devices, such as desktop 3D printing devices as a user-level 3D printing solution, and other subtractive processing devices like laser cutting and carving devices, are increasingly used to meet people's entertainment and other daily needs, and are used by growing number of individuals and families. Users can use a desktop 3D printing device or other subtractive processing devices to process multiple carriers with identical or uniform shapes to meet the needs of obtaining multiple finished products with uniformity. For example, the appearance of the processing devices enables users to freely process nameplates with multiple specified patterns and characters, that is, to complete the processing of specified patterns and characters on a specific-shaped carrier through processing printing devices. An urgent problem needs to be solved for the processing device is to realize batch processing of carriers with specific shapes.

### SUMMARY

The purpose of the present disclosure is to provide a processing control method, apparatus, and device to solve the technical problem of batch processing of carriers with undetermined shapes.

The present disclosure provides a processing control method includes:
obtaining a captured image of a processing platform, where at least one carrier is placed on the processing platform;
obtaining a pixel distribution, in a preset coordinate system, of the at least one carrier in the captured image;
determining a carrier among the at least one carrier in the captured image as a seed carrier; superimposing a target processing pattern on the seed carrier, and determining a position where the target processing pattern on the seed carrier is located in the preset coordinate system;
determining a target carrier in the captured image according to the pixel distribution of the at least one carrier in the preset coordinate system, where the target carrier is a carrier with a same shape as the seed carrier, among the at least one carrier; and
superimposing the target processing pattern on the target carrier in the captured image, based on the position where the target processing pattern on the seed carrier is located in the preset coordinate system, such that a relative position between the target carrier and the target processing pattern on the target carrier is equivalent to a relative position between the seed carrier and the target processing pattern on the seed carrier.

In an exemplary embodiment of the present disclosure, the obtaining a pixel distribution of the at least one carrier in a preset coordinate system includes:
performing edge detection on the captured image to obtain an edge-detected image;
extracting at least one closed shape from the edge-detected image, and performing color filling on the at least one closed shape, wherein an outline of the at least one closed shape corresponds to an outline of the carrier;
obtaining a binarized edge-detected image by binarizing the edge-detected image subjected to color filling; and
obtaining values of respective pixel points and positions of respective pixel points in the preset coordinate system, for each closed shape in the binarized edge-detected image, to obtain the pixel distribution of the at least one carrier in the preset coordinate system.

In an exemplary embodiment of the present disclosure, the determining a target carrier according to the pixel distribution of the at least one carrier in the preset coordinate system includes:
generating pixel distributions of modified seed carriers in the preset coordinate system based on the pixel distribution of the seed carrier in the preset coordinate system, where the modified seed carriers are obtained by rotating the seed carrier by a set of preset angles; and
performing a similarity matching between the at least one carrier and the modified seed carriers based on the pixel distribution of the at least one carrier and the pixel distributions of the modified seed carriers in the preset coordinate system, to determine the target carrier in the captured image.

In an exemplary embodiment of the present disclosure, the performing a similarity matching between the at least one carrier and the modified seed carriers based on the pixel distribution of the at least one carrier and the pixel distributions of the modified seed carriers in the preset coordinate system, to determine the target carrier in the captured image includes:
obtaining binarized images respectively corresponding to the at least one carrier and the modified seed carriers based on the pixel distribution of the at least one carrier and the pixel distribution of the modified seed carriers in the preset coordinate system;
scaling the binarized images to a preset size separately;
obtaining an overlap ratio of a first carrier among the at least one carrier to the modified seed carriers by performing an overlap matching between the scaled binarized image of the first carrier and the scaled binarized images of the modified seed carriers; and
determining the first carrier to be the target carrier if the overlap ratio of the first carrier to any modified seed carrier is greater than or equal to a preset threshold, and determining the first carrier not to be the target carrier if the overlap ratio of the first carrier to each modified seed carrier is less than the preset threshold.

In an exemplary embodiment of the present disclosure, the determining a target carrier in the captured image according to the pixel distribution of the at least one carrier in the preset coordinate system further includes:
performing the similarity matching between the at least one carrier and the modified seed carriers according to the pixel distribution of the at least one carrier and the pixel distributions of the modified seed carriers in the preset coordinate system, to determine a rotation angle of the target carrier relative to the seed carrier.

In an exemplary embodiment of the present disclosure, the superimposing the target processing pattern on the target carrier, based on the position where the target processing pattern on the seed carrier is located in the preset coordinate system includes:
obtaining a translation distance of the target carrier relative to the seed carrier according to the pixel distribution of the target carrier in the preset coordinate system; and
superimposing the target processing pattern on the target carrier in the captured image according to the translation distance and rotation angle of the target carrier and the position where the target processing pattern on the seed carrier is located in the preset coordinate system.

In an exemplary embodiment of the present disclosure, the superimposing the target processing pattern on the target carrier in the captured image according to the translation distance and rotation angle of the target carrier and the position where the target processing pattern on the seed carrier is located in the preset coordinate system includes:
obtaining a center offset between the target processing pattern on the seed carrier and the seed carrier according to the position where the target processing pattern on the seed carrier is located in the preset coordinate system;
obtaining the translation distance of the target processing pattern according to the translation distance, rotation angle and center offset of the target carrier;
translating the target processing pattern onto the target carrier in the captured image according to the translation distance of the target processing pattern; and
rotating the target processing pattern on the target carrier in the captured image according to the rotation angle of the target carrier.

In an exemplary embodiment of the present disclosure, the processing control method further includes:
generating GCODE instructions according to the position where the target processing pattern on the seed carrier is located in the preset coordinate system; and
processing the target carrier on the processing platform according to the GCODE instructions.

In a second aspect, a processing control apparatus is provided according to the present disclosure, and the processing control apparatus includes:
a captured image acquirer configured to acquire a captured image of a processing platform, where at least one carrier is placed on the processing platform;
a pixel distribution acquirer configured to acquire a pixel distribution, in a preset coordinate system, of the at least one carrier in the captured image;
a first superimposer configured to determine a carrier among the at least one carrier in the captured image as a seed carrier, to superimpose a target processing pattern on the seed carrier in the captured image, and to determine a position where the target processing pattern on the seed carrier is located in the preset coordinate system;
a target carrier determiner configured to determine a target carrier in the captured image according to the pixel distribution of the at least one carrier in the preset coordinate system, where the target carrier is a carrier with a same shape as the seed carrier, among the at least one carrier; and
a second superimposer configured to superimpose the target processing pattern on the target carrier in the captured image, based on the position where the target processing pattern on the seed carrier is located in the preset coordinate system, such that a relative position between the target carrier and the target processing pattern on the target carrier is equivalent to a relative position between the seed carrier and the target processing pattern on the seed carrier.

In a third aspect, a processing device is provided according to the present disclosure, and the processing device includes:
a processing platform for carrying at least one carrier;
a camera for capturing an image of the at least one carrier placed on the processing platform; and
the processing control apparatus according to the foregoing second aspect.

Other features and advantages of the present disclosure will become apparent from the following detailed description, or in part, be learned by practice of the present disclosure.

It is to be understood that both the foregoing general description and the following detailed description are exemplary and explanatory only and are not restrictive of the present disclosure.

### BRIEF DESCRIPTION OF THE DRAWINGS

The drawings, which are incorporated in and constitute a part of this specification, illustrate embodiments consistent with the present disclosure and are used to explain the principles of the present disclosure together with the description. Apparently, the drawings used in the following description show merely some embodiments of the present disclosure, and those skilled in the art can obtain other drawings based on these drawings without creative efforts.

FIG. 1 illustrates a schematic flowchart of a processing control method according to an embodiment of the present disclosure;

FIG. 2 illustrates a schematic diagram of processing control according to an embodiment of the present disclosure;

FIG. 3 illustrates a schematic flowchart of a method for obtaining pixel distributions according to an embodiment of the present disclosure;

FIG. 4 illustrates a schematic diagram of obtaining pixel distributions according to an embodiment of the present disclosure;

FIG. 5 illustrates a schematic diagram of a process for determining a target carrier according to an embodiment of the present disclosure;

FIG. 6 illustrates a schematic diagram of similarity matching according to an embodiment of the present disclosure;

FIG. 7 illustrates a schematic diagram of overlapping between carriers and modified seed carriers according to an embodiment of the present disclosure;

FIG. 8 illustrates a schematic structural diagram of a processing control apparatus according to an embodiment of the present disclosure; and

FIG. 9 illustrates a schematic structural diagram of a processing device according to another embodiment of the present disclosure.

### DETAILED DESCRIPTION

The technical solutions according to the embodiments of the present application are described clearly and completely as follows in conjunction with the drawings. It is apparent that the described embodiments are only a few rather than all of the embodiments according to the present application. All other embodiments acquired by those skilled in the art based on the embodiments of the present disclosure without any creative effort shall fall into the protection scope of the present disclosure.

In addition, the described characteristics, structures, or features may be combined in one or more embodiments in any appropriate manner. In the following descriptions, a lot of specific details are provided to give a comprehensive understanding of the embodiments of the present disclosure. However, those skilled in the art are to be aware that, the technical solutions in the present disclosure may be implemented without one or more of the particular details, or another method, unit, device, or step may be used. In other cases, well-known methods, devices, implementations, or operations are not shown or described in detail, in order to avoid obscuring aspects of the present disclosure.

The block diagrams in the drawings show merely functional entities and do not necessarily correspond to physically independent entities. In other words, such functional entities may be implemented in the form of software, or implemented in one or more hardware modules or integrated circuits, or implemented in different networks and/or processor apparatus and/or microcontroller apparatus.

The flowcharts shown in the drawings are merely for exemplary descriptions and do not necessarily include all of the content and operations/steps, nor are they necessarily performed in the sequence described. For example, some operations/steps may be further divided, and some operations/steps may be combined or partially combined. Therefore, an actual execution sequence may be changed according to an actual situation.

In the description of the present disclosure, the terms “first” and “second” are used for descriptive purposes only, and should not be understood as indicating or implying relative importance or implicitly indicating the number of indicated technical features. Therefore, the feature defined by “first” and “second” may explicitly or implicitly be one or more in number. In addition, in the description of the present application, “multiple or a plurality of” means two or more unless otherwise stated.

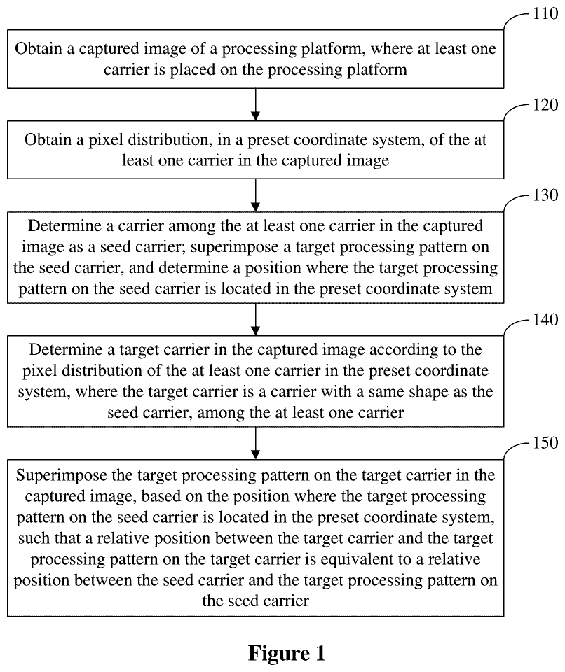

As shown in FIG. 1, the method at least includes the following steps from step 110 to step 150.

In step 110, a captured image of a processing platform is obtained, where at least one carrier is placed on the processing platform.

The carriers are processing materials to be cut or carved, which are in different shapes and sizes, such as the shape of a trapezoid, a circle and a triangle. The carriers are placed on the processing platform manually or by mechanical arms, and the carriers are located on the processing platform dispersedly.

In step 120, a pixel distribution, in a preset coordinate system, of the at least one carrier in the captured image is obtained.

The pixel distribution of the carrier in the preset coordinate system indicates the position and pixel value of each pixel point of the carrier in the preset coordinate system. It is noted that the position of the carrier in the captured image forms a mapping relationship with the position of the carrier on the processing platform, and the position of the carrier on the processing platform can be determined by determining the pixel distribution of the carrier in the captured image in the preset coordinate system.

In step 130, a carrier in the captured image is determined as a seed carrier; a target processing pattern is superimposed on the seed carrier, and a position where the target processing pattern on the seed carrier is located in the preset coordinate system is determined.

The target processing pattern is the pattern of a finished product obtained by cutting or carving the carriers. For example, if the user wishes to get a gear by processing, the target processing pattern is the shape of the gear. In a specific implementation, the captured image, that is, the target processing pattern, can be displayed in an image interaction interface, and the user can drag, in the image interaction interface, the target processing pattern onto a carrier in the captured image, and in this case the carrier being superimposed with the target processing pattern is the seed carrier.

In step 140, a target carrier in the captured image is determined according to the pixel distribution of the at least one carrier in the preset coordinate system, where the target carrier is a carrier with the same shape as the seed carrier, among the at least one carrier.

The target carrier is the carrier to be cut or carved with the target processing pattern. It should be noted that the target carrier has the same shape as the seed carrier, but may have a size different from the seed carrier. The carrier with characteristics similar to the seed carrier is determined as the target carrier, based on the pixel distribution of all the carriers in the preset coordinate system.

In step 150, the target processing pattern is superimposed on the target carrier, based on the position where the target processing pattern on the seed carrier is located in the preset coordinate system, such that a relative position between the target carrier and the target processing pattern on the target carrier is equivalent to a relative position between the seed carrier and the target processing pattern on the seed carrier.

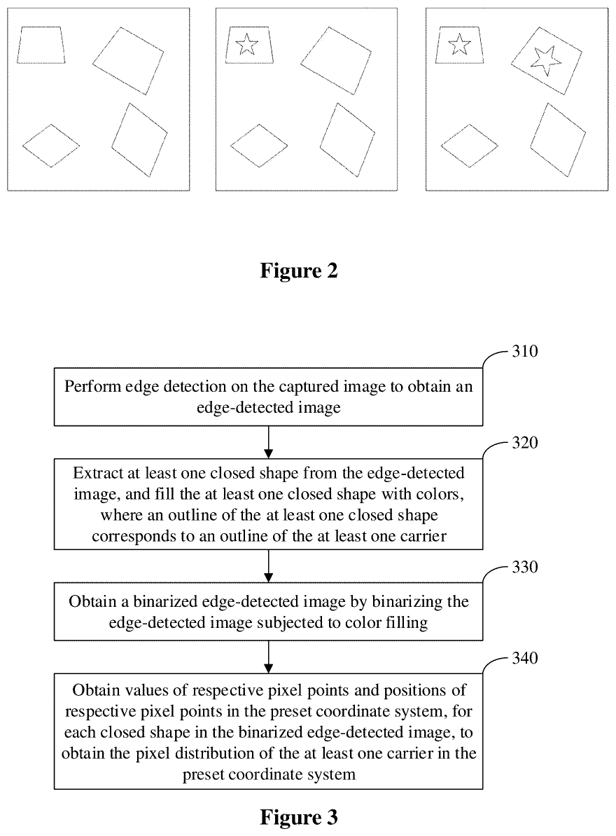

As shown in FIG. 2, the left picture shows the captured image which includes multiple carriers, and the carriers are trapezoidal and rhombic: the middle picture shows the image with the target processing pattern dragged to the seed carrier in the captured image, the target processing pattern is a five-pointed star, and the five-pointed star is superimposed on a trapezoidal carrier; the right picture shows the image with copies of the target processing pattern superimposed on all the target carriers in the captured image, i.e., copies of the five-pointed star is superimposed on all the trapezoidal carriers.

It should be noted that there may be seed carriers of various shapes, and there may be one or more target processing patterns. For example, both the trapezoidal carrier and the triangular carrier are seed carriers, and the target processing pattern on the trapezoidal carrier is a five-pointed star, the target processing pattern on the triangular carrier is a four-pointed star. In the present disclosure, the five-pointed star can be superimposed on other trapezoidal carriers, and the four-pointed star can be superimposed on other triangular carriers.

In the embodiments of the disclosure, by identifying the shape and pixel distribution of all carriers on the processing platform, the target processing pattern is copied to the target carrier with the same shape as the seed carrier, so that the carriers with the same shape can be processed in batches by using the target processing pattern, and user experience is improved.

As shown in FIG. 3, the method at least includes the following steps from step 310 to step 340.

In step 310, edge detection is performed on the captured image to obtain an edge-detected image.

The carriers have a color contrast with respect to the processing platform, so the edge-detected image is obtained based on the color contrast between the carries and the background in the captured image, the edge-detected image includes the outline of each carrier, that is, each closed shape.

In step 320, at least one closed shape in the edge-detected image is extracted, and color filling is performed for the at least one closed shape, where the outline of the closed shape corresponds to the outline of the carrier.

In step 330, a binarized edge-detected image is obtained by binarizing the edge-detected image subjected to color filling.

The binarization process converts the value of the pixels in the image to 0 or 255, that is, being displayed as black or white, so after the binarization process, the color of the pixels in the closed shape is black, and the color of the pixels outside the closed shape is white.

In step 340, values of respective pixel points and positions of respective pixel points in the preset coordinate system are obtained for each closed shape in the binarized edge-detected image, to obtain the pixel distribution of the at least one carrier in the preset coordinate system.

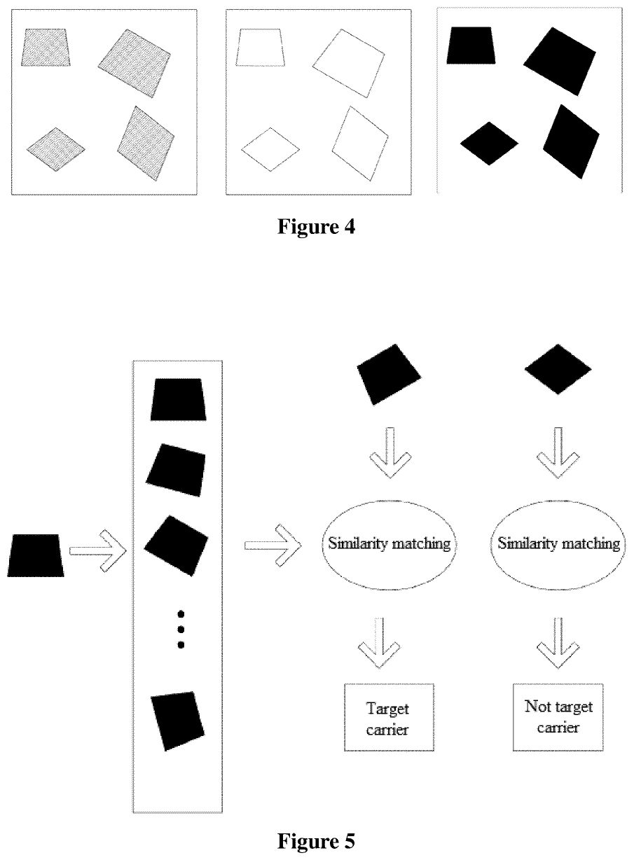

As shown in FIG. 4, the captured image is on the left, the edge-detected image is in the middle, and the binarized image is on the right.

In the embodiment of the present disclosure, the positions and pixel values of pixels of the carriers in the preset coordinate system are determined through edge detection and binarization processing, for subsequently determining the target carrier.

In some embodiments of the present disclosure, based on the above scheme, determining the target carrier in the captured image according to the pixel distribution of the at least one carrier in the preset coordinate system includes:
generating pixel distributions of modified seed carriers in the preset coordinate system based on the pixel distribution of the seed carrier in the preset coordinate system, where the modified seed carriers are obtained by rotating the seed carrier by a set of preset angles;
performing a similarity matching between the at least one carrier and the modified seed carriers based on the pixel distribution of the at least one carrier and the pixel distributions of the modified seed carriers in the preset coordinate system, to determine the target carrier in the captured image.

In a specific implementation, the set of preset angles is [0, 1, 2, 3 . . . 358, 359], and the modified seed carriers are obtained by rotating the seed carrier by 0 to 359 degrees. It may be determined whether the carrier is the target carrier and the rotation angle of the carrier relative to the seed carrier by performing the similarity matching between the carriers in the captured image and a set of modified seed carriers.

As shown in FIG. 5, the trapezoidal carrier is used as the seed carrier and rotated from 1 to 359 degrees to form the set of modified seed carriers, and similarity matching is performed for each carrier in the captured image with the modified seed carriers one by one to determine whether the carrier is the target carrier.

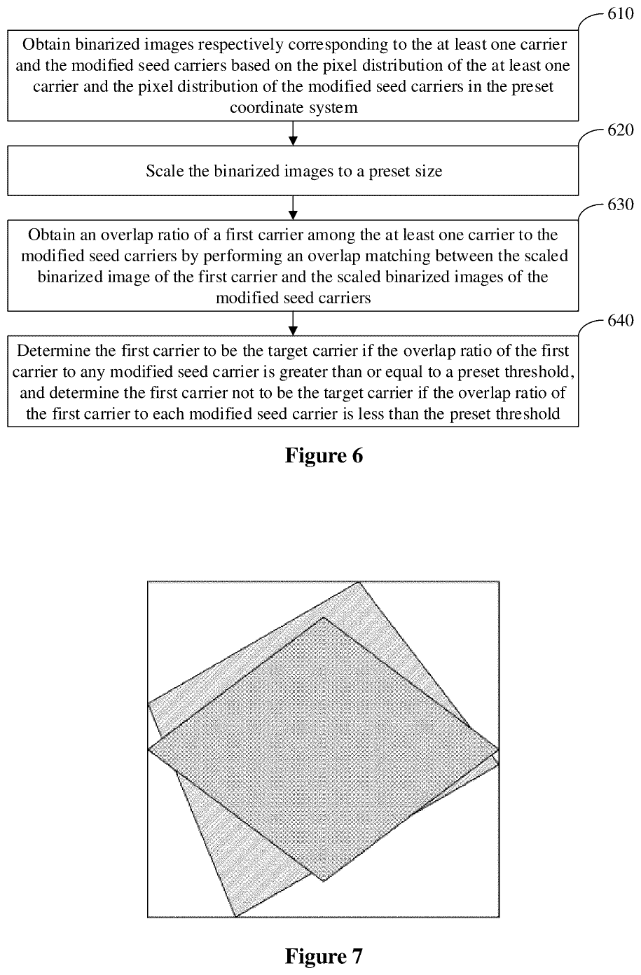

As shown in FIG. 6, the method at least includes the following steps from step 620 to step 640.

In step 610, binarized images respectively corresponding to the at least one carrier and the modified seed carriers are obtained based on the pixel distribution of the at least one carrier and the pixel distribution of the modified seed carriers in the preset coordinate system.

In a specific implementation, the area where the minimum bounding rectangle of the carrier is located, namely, the target detection area of the carrier, may be binarized and used as a binarized image.

In step 620, the binarized images are separately scaled to a preset size.

Since the size of the carriers may be different, in order to determine whether the pixel distribution characteristics of the carriers and the modified seed carriers are the same, it is to scale the binarized images corresponding to the carriers and the modified seed carriers to the same size.

In step 630, an overlap ratio of a first carrier among the at least one carrier to the modified seed carriers is obtained by performing an overlap matching between the scaled binarized image of the first carrier and the scaled binarized images of the modified seed carriers.

The overlapping area between the carrier and the modified seed carriers are the pixel areas where both are black pixels and where both are white pixels. The overlap ratio of the carrier to the modified seed carrier is determined based on the number of pixels in the overlapping area and the total number of pixels in the binarized images of the carrier.

In step 640, the first carrier is determined to be the target carrier if the overlap ratio of the first carrier to any modified seed carrier is greater than or equal to a preset threshold, and the first carrier is determined not to be the target carrier if the overlap ratio of the first carrier to each modified seed carrier is less than a preset threshold.

The preset threshold may be set according to the resolution of the captured image. For example, the preset threshold is set to 80%, the first carrier is determined to be the target carrier if the overlap ratio is greater than or equal to 80%, and the first carrier is determined not to be the target carrier if the overlap ratio is less than 80%.

It should be noted that the first carrier here generally refers to any carrier in the captured image. In specific implementations, it is to overlap and match each carrier in the captured image with the modified seed carriers one by one to determine whether the carrier is the target carrier or not.

As shown in FIG. 7, the trapezoidal carrier is a modified seed carrier, the overlap ratio of the triangular carrier and the modified seed carrier is not high, and the triangular carrier is not the target carrier.

In some embodiments of the present disclosure, based on the above scheme, determining a target carrier in the captured image according to the pixel distribution of at least one carrier in the preset coordinate system includes:
performing a similarity matching between the at least one carrier and the modified seed carriers according to the pixel distribution of the at least one carrier and the pixel distributions of the modified seed carriers in the preset coordinate system to determine a rotation angle of the target carrier relative to the seed carrier.

If the overlap ratio between the carrier and a certain modified seed carrier is greater than the preset threshold, the rotation angle of the carrier relative to the seed carrier is equal to the rotation angle of the modified seed carrier relative to the seed carrier.

In some embodiments of the present disclosure, based on the above scheme, superimposing the target processing pattern on the target carrier in the captured image, based on the position where the target processing pattern on the seed carrier is located in the preset coordinate system includes:
obtaining a translation distance of the target carrier relative to the seed carrier according to the pixel distribution of the target carrier in the preset coordinate system;
superimposing the target processing pattern on the target carrier in the captured image according to the translation distance and rotation angle of the target carrier and the position where the target processing pattern on the seed carrier is located in the preset coordinate system.

In a specific implementation, after the pixel distribution of all carriers in the captured image is known, the center of the carrier can be determined, and the translation distance of the center of the target carrier relative to the center of the seed carrier can be determined. Once knowing the position where the target processing pattern on the seed carrier is located in the preset coordinate system, the center of the target processing pattern can be translated and then rotated to obtain the position of the processing pattern on the target carrier.

In some embodiments of the present disclosure, based on the above scheme, the superimposing the target processing pattern on the target carrier in the captured image according to the translation distance and rotation angle of the target carrier and the position where the target processing pattern on the seed carrier is located in the preset coordinate system includes:
obtaining a center offset between the target processing pattern on the seed carrier and the seed carrier according to the position where the target processing pattern on the seed carrier is located in the preset coordinate system;
obtaining the translation distance of the target processing pattern according to the translation distance, rotation angle and center offset of the target carrier;
translating the target processing pattern to the target carrier in the captured image according to the translation distance of the target processing pattern; and
rotating the target processing pattern on the target carrier in the captured image according to the rotation angle of the target carrier.

It is worth noting that the center of the target processing pattern and the center of the seed carrier may not coincide. If the center of the target processing pattern is directly translated according to the translation distance of the target carrier, the relative position between the target carrier and the target processing pattern corresponding to the target carrier is not equivalent to the relative position between the seed carrier and the target processing pattern corresponding to the seed carrier. Therefore, it is to obtain the center offset between the target processing pattern and the seed carrier first, and then obtain the translation distance of the center of the target processing pattern.

It should be noted that if the size of the target carrier is different from that of the seed carrier, it is to obtain the scaling ratio of the target carrier relative to the seed carrier. Correspondingly, the scaling ratio of the target carrier will affect the translation distance of the center of the target processing pattern on the target carrier. After the translation and rotation of the target processing pattern are completed, a conversion at the corresponding scaling ratio is also required.

In some embodiments of the present disclosure, based on the above solution, the processing control method further includes:
generating GCODE instructions according to the position where the target processing pattern on the seed carrier is located in the preset coordinate system;
processing the target carrier on the processing platform according to the GCODE instructions.

GCODE is an international standard language for the Computerized Numerical Control Industry. In the specific implementation, after the position of the target processing pattern in the preset coordinate system is obtained, the contour vector of the target processing pattern can be determined to determine the GCODE instruction. The carrier on the processing platform is processed, by controlling the movement track of the fixture according to the GCODE instructions, to obtain the finished product.

The embodiments of the processing control apparatus according to the present disclosure are described hereinafter, which can be used to implement the processing control methods in the above-mentioned embodiments of the present disclosure. For the details not disclosed in the embodiments of the processing control apparatus in the present disclosure, reference may be made to the above embodiments of the processing control method in the present disclosure.

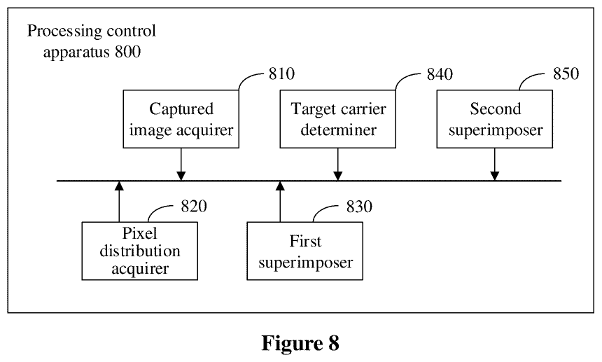

As shown in FIG. 8, the processing control apparatus 800 includes at least:
a captured image acquirer 810, which is configured to acquire a captured image of the processing platform, where at least one carrier is placed on the processing platform;
a pixel distribution acquirer 820, which is configured to acquire a pixel distribution of the at least one carrier in the captured image in the preset coordinate system;
a first superimposer 830, which is configured to determine a carrier among the at least one carrier in the captured image as a seed carrier, to superimpose a target processing pattern on the seed carrier in the captured image, and to determine a position where the target processing pattern on the seed carrier is located in the preset coordinate system;
a target carrier determiner 840, which is configured to determine the target carrier in the captured image according to the pixel distribution of the at least one carrier in the preset coordinate system, where the target carrier is a carrier with the same shape as the seed carrier, among the at least one carrier; and
a second superimposer 850, which is configured to superimpose the target processing pattern on the target carrier in the captured image according to the position where the target processing pattern on the seed carrier is located in the preset coordinate system, such that a relative position between the target carrier and the target processing pattern on the target carrier is equivalent to a relative position between the seed carrier and the target processing pattern on the seed carrier.

A processing device is further provided according to the embodiment of the present disclosure, which includes:
a processing platform for carrying at least one carrier;
a camera for capturing an image of the at least one carrier placed on the processing platform; and
the foregoing processing control apparatus.

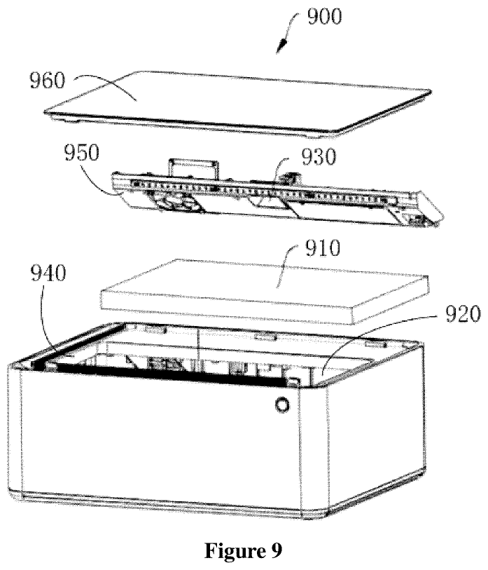

As shown in FIG. 9, the processing device is a laser and cutting processing device 900. The laser and cutting processing device 900 includes a frame 940 provided with a closed processing space 920. The processing space 920 is configured for accommodating and processing a work piece to be processed (such as a printed matter to be processed). The frame 940 is provided with a top opening connected with the processing space 920. The frame 940 is also connected with a cover plate 960. The cover plate 960 covers the opening in a rotatable manner. The opening is provided for users to put in a work piece to be processed or take out a processed work piece. The frame 940 is formed by a base plate, side plates, and the like. In the frame 940, there is provided with a track and the processing apparatus arranged on the track. The processing apparatus can move in the X, Y, and Z axis directions in the processing space 920. The processing apparatus includes a laser and a cutting tool, so as to move and carve and cut the work piece with the laser, or cut and scratch the work piece with the cutting tool, which can realize desktop-level and miniaturized settings of the laser and cutting processing device.

A camera 930 is arranged in the laser and cutting processing device, and the processing platform 910 is arranged at the bottom of the processing space 920. The camera 930 faces the processing platform 910 to capture pictures during the processing. For example, the image of the carrier on the processing platform is captured.

The laser and cutting processing device 900 according to the embodiment of the present disclosure includes a mounting bracket 950 arranged in the frame 940. The camera 930 is arranged on the mounting bracket 950 inside the laser and cutting processing device 900. Compared with the configuration of arranging the camera 930 on the cover plate 960, the solution of the embodiment of the present disclosure not only simplifies the wiring of the camera 930, but also can better prevent the deformation of the cover plate 960 or the change of the position of the camera 930 caused by repeated opening and closing, thereby avoiding the debugging before laser processing, improving the processing accuracy and processing efficiency. In addition, compared with the configuration of arranging the camera 930 on the cover plate 960, the configuration of arranging the camera 930 on the mounting bracket 950 can lower the overall height of the entire laser and cutting processing device 900 while ensuring capture the image of the entire work piece to be processed, thereby facilitating users to place the work piece to be processed (when the user places the work piece to be processed, the user's hand will go deep into the processing space 920 or the frame 940; and if the laser and cutting processing device 900 is too high, it is inconvenient for user operation).

The camera 930 is arranged in the middle of the mounting bracket 950. By arranging the camera 930 in the middle of the mounting bracket 950, the image of the entire work piece to be processed can be better captured. The term “middle” in the present disclosure refers to the center position of the component, or a part close to the center position. Optionally, the camera is arranged at the bottom of an accommodating groove. This can better prevent the camera from accidentally injuring when the work piece is processed, and has a better dust-proof effect, improving the service life of the camera. The equivalent circle diameter of the accommodating groove decreases gradually from the arranging surface to the bottom of the accommodating groove, which can better prevent the side wall of the accommodating groove from affecting the shooting effect of the camera.

In the embodiments of the disclosure, the target processing pattern is copied to the target carrier with the same shape as the seed carrier by identifying the shape and pixel distribution of all carriers on the processing platform, so that the carriers with the same shape can be processed in batches by using the target processing pattern, and user experience is improved.

A storage medium is further provided according to an embodiment of the present disclosure, including a program or an instruction. The processing control method or any optional method according to the embodiments of the present disclosure is implemented when the program or instruction is executed.

Finally, it should be noted that, those skilled in the art should understand that the embodiments of the present disclosure may be provided as methods, systems, or computer program products. Accordingly, the present disclosure can take the form of an entire hardware embodiment, an entire software embodiment, or an embodiment combining software and hardware aspects. Furthermore, the present disclosure may take the form of a computer program product embodied on one or more computer-usable storage media (including but not limited to disk storage, optical storage, etc.) having computer-usable program code embodied therein.

The present disclosure is described with reference to flowcharts and/or block diagrams of methods, apparatus (systems), and computer program products according to the present disclosure. It should be understood that each process and/or block in the flowcharts and/or block diagrams, and a combination of processes and/or blocks in the flowcharts and/or block diagrams can be implemented by computer program instructions. These computer program instructions may be provided to a general purpose computer, special purpose computer, embedded processor, or processor of other programmable data processing devices to produce a machine, such that the instructions executed by the processor of the computer or other programmable data processing devices can produce an apparatus for realizing the functions specified in one or more procedures of the flowcharts and/or one or more blocks of the block diagrams.

These computer program instructions may also be stored in a computer-readable memory capable of directing a computer or other programmable data processing device to operate in a specific manner, such that the instructions stored in the computer-readable memory produce an article including an instruction apparatus. The instruction apparatus realizes the function specified in one or more procedures of the flowcharts and/or one or more blocks of the block diagrams.

Specific embodiments of the present disclosure are described above, but the scope of the present disclosure is not limited thereto. Any changes or substitutions that can be easily conceived by those skilled in the art within the technical scope disclosed in the present disclosure fall into the scope of the present disclosure. Therefore, the scope of the present disclosure is defined by the claims.

1. A processing control method, comprising:
obtaining a captured image of a processing platform, wherein at least one carrier is placed on the processing platform;
determining a carrier among the at least one carrier in the captured image as a seed carrier, wherein the seed carrier is superimposed with a target processing pattern;
determining a target carrier in the captured image, wherein the target carrier is a carrier that matches a shape of the seed carrier, among the at least one carrier; and
superimposing the target processing pattern on the target carrier in the captured image.

2. The processing control method according to claim 12, wherein the obtaining a pixel distribution of the at least one carrier in the captured image comprises:
performing edge detection on the captured image to obtain an edge-detected image;
extracting at least one closed shape from the edge-detected image, and performing color filling on the at least one closed shape, wherein an outline of the at least one closed shape corresponds to an outline of the carrier;
obtaining a binarized edge-detected image by binarizing the edge-detected image subjected to color filling; and
obtaining values of respective pixel points and positions of respective pixel points, for each closed shape in the binarized edge-detected image, to obtain the pixel distribution of the at least one carrier.

3. The processing control method according to claim 12, wherein the determining a target carrier in the captured image according to the pixel distribution of the at least one carrier comprises:
generating pixel distributions of modified seed carriers based on the pixel distribution of the seed carrier, wherein the modified seed carriers are obtained by rotating the seed carrier by a set of preset angles; and
performing a similarity matching between the at least one carrier and the modified seed carriers based on the pixel distribution of the at least one carrier and the pixel distributions of the modified seed carriers, to determine the target carrier in the captured image.

4. The processing control method according to claim 3, wherein the performing a similarity matching between the at least one carrier and the modified seed carriers based on the pixel distribution of the at least one carrier and the pixel distributions of the modified seed carriers, to determine the target carrier in the captured image comprises:
obtaining binarized images respectively corresponding to the at least one carrier and the modified seed carriers based on the pixel distribution of the at least one carrier and the pixel distribution of the modified seed carriers;
scaling the binarized images to a preset size separately;
obtaining an overlap ratio of a first carrier among the at least one carrier to the modified seed carriers by performing an overlap matching between the scaled binarized image of the first carrier and the scaled binarized images of the modified seed carriers; and
determining the first carrier to be the target carrier if the overlap ratio of the first carrier to any modified seed carrier is greater than or equal to a preset threshold.

5. The processing control method according to claim 3, wherein the pixel distribution of the at least one carrier is determined in a preset coordinate system, and the determining a target carrier in the captured image according to the pixel distribution of the at least one carrier further comprises:
performing the similarity matching between the at least one carrier and the modified seed carriers according to the pixel distribution of the at least one carrier and the pixel distributions of the modified seed carriers in the preset coordinate system, to determine a rotation angle of the target carrier relative to the seed carrier.

6. The processing control method according to claim 13, wherein the superimposing the target processing pattern on the target carrier in the captured image, based on the position where the target carrier is located in the preset coordinate system and the rotation angle of the target carrier comprises:
obtaining a translation distance of the target carrier relative to the seed carrier according to the pixel distribution of the target carrier in the preset coordinate system; and
superimposing the target processing pattern on the target carrier in the captured image according to the translation distance and the rotation angle of the target carrier and the position where the target processing pattern on the seed carrier is located in the preset coordinate system.

7. The processing control method according to claim 6, wherein the superimposing the target processing pattern on the target carrier in the captured image according to the translation distance and rotation angle of the target carrier and the position where the target processing pattern on the seed carrier is located in the preset coordinate system comprises:
obtaining a center offset between the target processing pattern on the seed carrier and the seed carrier according to the position where the target processing pattern on the seed carrier is located in the preset coordinate system;
obtaining the translation distance of the target processing pattern according to the translation distance, rotation angle and center offset of the target carrier;
translating the target processing pattern onto the target carrier in the captured image according to the translation distance of the target processing pattern; and
rotating the target processing pattern on the target carrier in the captured image according to the rotation angle of the target carrier.

8. The processing control method according to claim 1 further comprising:
generating machining instructions according to the position where the target processing pattern on the seed carrier is located in a preset coordinate system; and
processing the target carrier on the processing platform according to the machining instructions.

9. (canceled)

10. A processing device comprising:
a processing platform for carrying at least one carrier;
a camera for capturing an image of the at least one carrier placed on the processing platform; and
a controller configured to:
obtain a captured image of a processing platform, wherein at least one carrier is placed on the processing platform;
determine a carrier among the at least one carrier in the captured image as a seed carrier, wherein the seed carrier is superimposed with a target processing pattern;
determine a target carrier in the captured image, wherein the target carrier is a carrier that matches a shape of the seed carrier, among the at least one carrier; and
superimpose the target processing pattern on the target carrier in the captured image.

11. The processing control method according to claim 1, wherein superimposing the target processing pattern on the target carrier in the captured image comprises making a relative position between the target carrier and the target processing pattern on the target carrier is equivalent to a relative position between the seed carrier and the target processing pattern on the seed carrier.

12. The processing control method according to claim 1, further comprising obtaining a pixel distribution of the at least one carrier in the captured image, and determining the target carrier based on the pixel distribution of the at least one carrier.

13. The processing control method according to claim 5, wherein superimposing the target processing pattern on the target carrier in the captured image comprises:
determining a position where the target carrier is located in the preset coordinate system; and
superimposing the target processing pattern on the target carrier in the captured image, based on the position where the target carrier is located in the preset coordinate system and the rotation angle of the target carrier.

14. The processing control method according to claim 5, further comprising:
in response to determining that the overlap ratio between a carrier among the at least one carrier and any modified seed carrier is greater than the preset threshold, determining the carrier as the target carrier and determining a rotation angle of the modified seed carrier relative to the seed carrier as the rotation angle of the carrier relative to the seed carrier.

15. The processing control method according to claim 2, further comprising:
determining closed shapes of the at least one carrier by performing the edge detection based on a color contrast between the at least one carrier and a background of the captured image.

16. The processing device according to claim 10, further comprising a display, wherein the display is configured to present a graphical interactive interface for user to superimpose the target processing pattern on the at least one carrier.

17. The processing device according to claim 10, further comprising a frame, wherein an enclosed processing space is defined inside the frame, the frame is provided with a top opening that is in communication with the processing space, and the frame is further connected to a cover plate which covers the opening in a rotatable manner.

18. The processing device according to claim 17, further comprising a processing tool configured to process the target carrier on the processing platform.

19. The processing device according to claim 18, wherein a track is provided inside the frame and the processing tool is arranged on the track so that the processing tool is movable to implement processing inside the processing space along at least one of an X-axis direction, a Y-axis direction, and a Z-axis direction.

20. The processing device according to claim 17, further comprising a mounting bracket arranged in the frame, wherein the camera is arranged on the mounting bracket.

21. A non-transitory computer readable storage medium having a program stored thereon, wherein the program, when being executed by a processor, cause the processor to implement:
obtaining a captured image of a processing platform, wherein at least one carrier is placed on the processing platform;
determining a carrier among the at least one carrier in the captured image as a seed carrier, wherein the seed carrier is superimposed with a target processing pattern;
determining a target carrier in the captured image, wherein the target carrier is a carrier that matches a shape of the seed carrier, among the at least one carrier; and
superimposing the target processing pattern on the target carrier in the captured image.
